(19) United States
(12) Patent Application Publication
(10) Pub. No.: US 2025/0267739 A1
(43) Pub. Date: Aug. 21, 2025

(54) ELECTRONIC DEVICE FOR MANAGING APPLICATION RELATED TO DIGITAL KEY TO EXTERNAL DEVICE AND OPERATION METHOD THEREFOR

(71) Applicant: Samsung Electronics Co., Ltd., Suwon-si (KR)

(72) Inventors: Janghyun NAM, Suwon-si (KR); Geonwoo KIM, Suwon-si (KR); Jeongsoo KIM, Suwon-si (KR); Hyoseok NA, Suwon-si (KR)

(21) Appl. No.: 19/203,799

(22) Filed: May 9, 2025

Related U.S. Application Data
(63) Continuation of application No. PCT/KR2023/018167, filed on Nov. 13, 2023.

(30) Foreign Application Priority Data
Nov. 11, 2022 (KR) 10-2022-0150529
Dec. 14, 2022 (KR) 10-2022-0174723

(51) Int. Cl. H04W 76/14; H04W 4/80

(52) U.S. Cl. CPC H04W 76/14; H04W 4/80

(57) ABSTRACT

An electronic device may comprise: a communication circuitry configured to establish an NFC communication connection with an external electronic device, a memory, and a processor. The processor may be configured to: receive an application identifier (AID) of a first device based on a communication connection with the first device being established or an application capable of driving the first device running; acquire information based on an antenna of a second device related to the first device on the memory or a server based on the application identifier of the first device; and display, on a display, a guide indicating the location at which the electronic device will be disposed on the second device in order to establish a communication connection with the second device based on the location of the antenna of the second device and the location of an antenna of the electronic device.

### CROSS-REFERENCE TO RELATED APPLICATIONS

This application is a continuation of International Application No. PCT/KR2023/018167 designating the United States, filed on Nov. 13, 2023, in the Korean Intellectual Property Receiving Office and claiming priority to Korean Patent Application Nos. 10-2022-0150529, filed on Nov. 11, 2022, and 10-2022-0174723, filed on Dec. 14, 2022, in the Korean Intellectual Property Office, the disclosures of each of which are incorporated by reference herein in their entireties.

### BACKGROUND

### Field

The disclosure relates to an electronic device for managing an application related to a digital key of an external electronic device and an operation method for an electronic device.

### Description of Related Art

Various electronic devices such as a smart phone, a tablet PC, a portable multimedia player (PMP), personal digital assistant (PDA), a laptop personal computer (laptop PC), and a wearable device are being distributed.

Various electronic devices being distributed recently support various short-range wireless communication schemes. The short-range wireless communication scheme may include Bluetooth, near field communication (NFC) supporting two-way communication, and/or radio frequency identification (RFID) supporting one-way communication.

Among the short-range wireless communication schemes, the NFC communication scheme may be a communication scheme capable of transmitting and/or receiving data to and from external electronic devices that are close within a certain distance from the electronic device. The NFC communication scheme may support a card mode in which the electronic device outputs a signal including data and a basic mode in which the electronic device outputs a signal including data or receives the signal including data. The external electronic device supporting the NFC may be implemented as an NFC tag.

The electronic device may receive data stored in the NFC tag, receive various types of content using the data stored in the NFC tag, and provide the received content to a user. The NFC communication scheme may be used when controlling a vehicle. According to one example, the electronic device may transmit data required for authentication of the electronic device while being close to an NFC reader disposed on a part of the vehicle (e.g., a door handle) within a certain distance. The vehicle may receive the data required for the authentication of the electronic device, and when the authentication of the electronic device is successful, perform various functions (e.g., opening and closing of a door and/or activation of start).

A size and/or location of an NFC antenna of the NFC reader disposed on the vehicle may be different from each other. The size and/or location of the antenna of the electronic device supporting the NFC may also be different from each other, so a recognition rate of the electronic device may be different from each other for each vehicle.

### SUMMARY

According to an example embodiment, an electronic device may include: a communication circuit configured to establish an NFC communication connection with an external electronic device, a memory, and at least one processor, comprising processing circuitry. At least one processor, individually and/or collectively, may be configured to cause the electronic device to: receive an application identifier (AID) of a first device based on a communication connection with the first device being established or an application capable of driving the first device running, acquire information based on an antenna of a second device related to the first device on the memory or a server based on the application identifier of the first device, and display, on a display, a guide indicating a location at which the electronic device is to be disposed on the second device to establish communication connection with the second device based on the location of the antenna of the second device and a location of an antenna of the electronic device.

According to an example embodiment, a method of operating an electronic device including an NFC antenna may include: receiving an application identifier (AID) of a first device based on a communication connection with the first device being established or an application capable of driving the first device running, acquiring location information about an antenna of a second device related to the first device on the memory or a server based on the application identifier of the first device, determining a location of the electronic device for establishing communication connection with the second device based on a location of the antenna of the second device and a location of an antenna of the electronic device, and displaying information indicating the determined location of the electronic device on a display.

According to an example embodiment, an electronic device supporting an NFC operation mode may obtain information about a reader on a car side and store an optimal location between the electronic device and the reader on the car inside the electronic device. The electronic device may guide the user to the optimal location between the electronic device and the reader on the car in the situations where the electronic device is used as a digital key.

The electronic device supporting the NFC operation mode according to the present disclosure may optimize and/or improve NFC parameters to match the reader on the car side in order to increase the level of the sensitivity of the electronic device connected to the reader on the car side in the situations where the electronic device is connected to the reader on the car side.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a block diagram illustrating an example electronic device in a network environment according to various embodiments;

FIG. 2A is a block diagram illustrating an example configuration of a wireless communication module, a power management module, and an antenna module of an electronic device according to various embodiments;

FIG. 2B is a diagram illustrating an example configuration of the electronic device according to various embodiments;

FIG. 3 is a block diagram illustrating an example configuration of the electronic device according to various embodiments;

FIG. 4A is a diagram illustrating an antenna structure of a reader of an external electronic device according to various embodiments;

FIG. 4B is a diagram illustrating a situation where the electronic device (e.g., a terminal) is mounted on an NFC reader of the external electronic device according to various embodiments;

FIG. 5A is a diagram illustrating a situation where the electronic device is recognized on a first NFC antenna according to various embodiments;

FIG. 5B is a diagram illustrating a situation where the electronic device is recognized on a second NFC antenna according to various embodiments;

FIG. 5C is a diagram illustrating a situation where the electronic device is recognized on the second NFC antenna according to various embodiments;

FIG. 6 is a flowchart illustrating an example method of operating an electronic device supporting an NFC operation mode according to various embodiments; and

FIG. 7 is a flowchart illustrating an example method of operating an electronic device supporting an NFC operation mode according to various embodiments.

### DETAILED DESCRIPTION

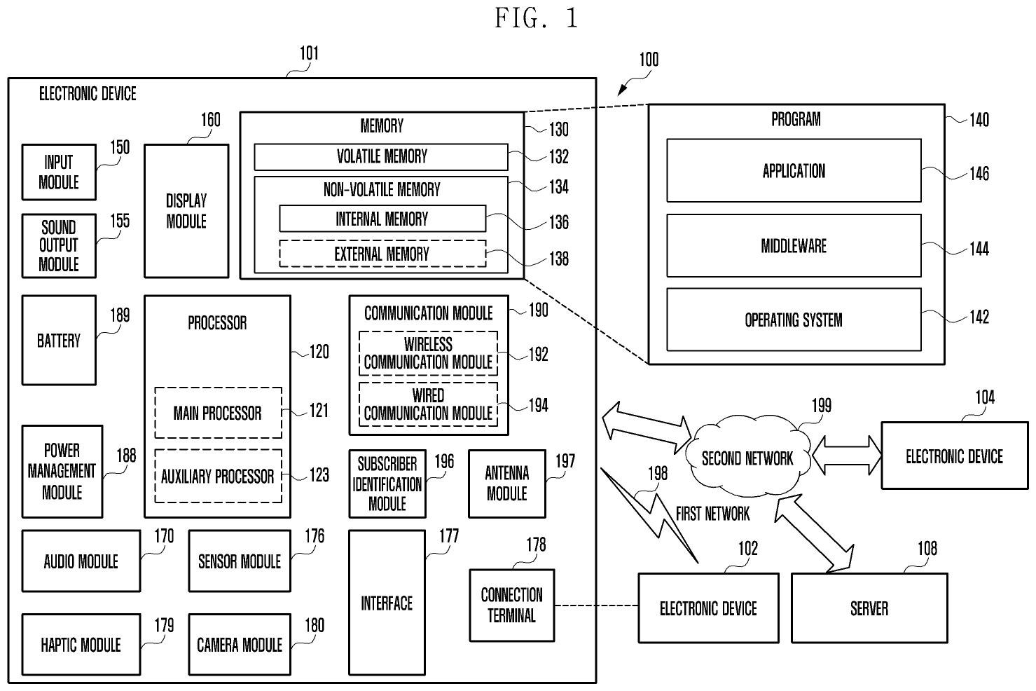

FIG. 1 is a block diagram illustrating an electronic device 101 in a network environment 100 according to various embodiments. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network).

According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In various embodiments, at least one of the components (e.g., the connecting terminal 178) may be omitted from the electronic device 101, or one or more other components may be added in the electronic device 101. In various embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121. Thus, the processor 120 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IM SI)) stored in the subscriber identification module 196.

The wireless communication module 192 may support a 5G network, after a 4G network, and next-generation communication technology, e.g., new radio (NR) access technology. The NR access technology may support enhanced mobile broadband (eM BB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eM BB, loss coverage (e.g., 164 dB or less) for implementing mM TC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., wiredly), wirelessly, or via a third element.

As used in connection with various embodiments of the disclosure, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (A SIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

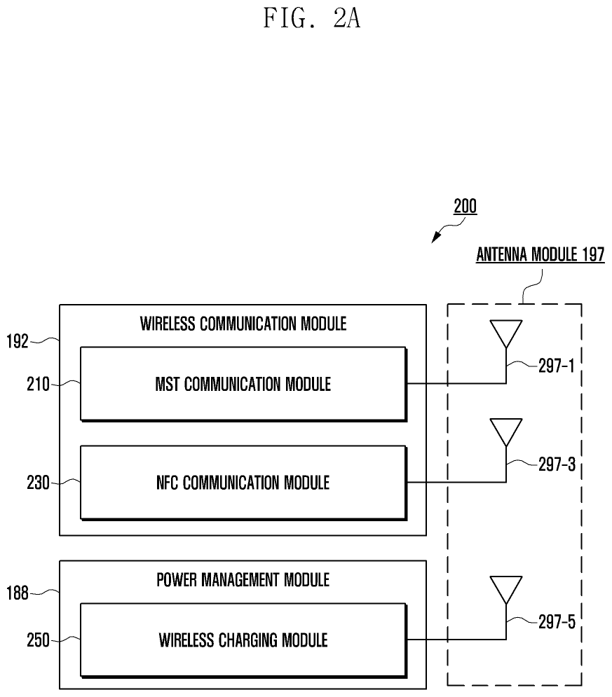

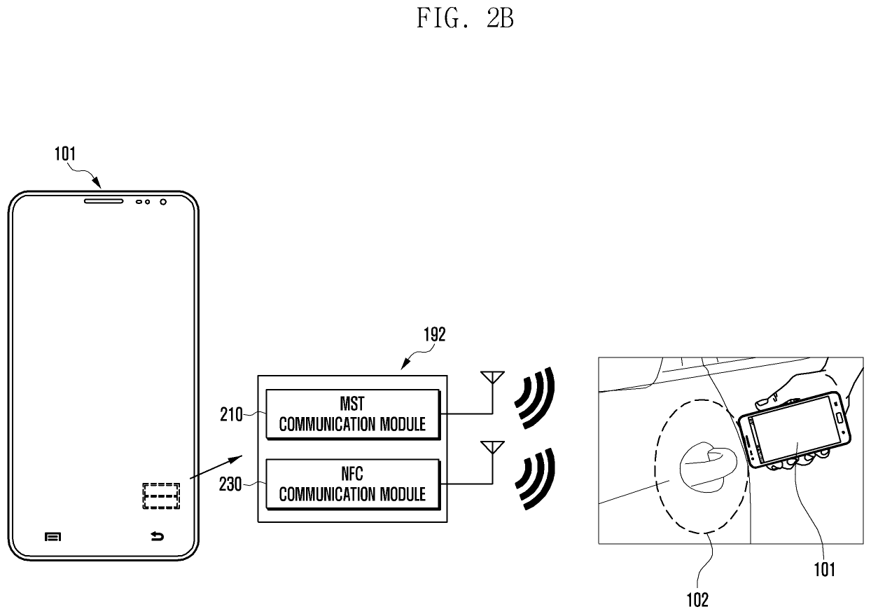

FIG. 2A is a block diagram 200 illustrating an example configuration of a wireless communication module 192, a power management module 188, and an antenna module 197 of an electronic device 101 according to various embodiments. Referring to FIG. 2, the wireless communication module 192 may include an MST communication module (e.g., including MST communication circuitry) 210 and/or an NFC communication module (e.g., including NFC communication circuitry) 230, and the power management module (e.g., including power management circuitry) 188 may include a wireless charging module (e.g., including wireless charging circuitry) 250. In this case, an antenna module 297 may include a plurality of antennas that include an MST antenna 297-1 connected to the MST communication module 210, an NFC antenna 297-3 connected to the NFC communication module 230, and a wireless charging antenna 297-5 connected to the wireless charging module 250. For convenience of description, description of components that overlap with FIG. 1 may not be repeated here.

The MST communication module 210 may include various MST communication circuitry and receive a signal that includes control information or authentication information such as card information from a processor 120, generate a magnetic signal corresponding to the received signal through the MST antenna 297-1, and then transmit the generated magnetic signal to an external electronic device 102 (e.g., a POS device). In order to generate the magnetic signal, according to an embodiment, the MST communication module 210 may include a switching module (e.g., including at least one switch) (not illustrated) that includes one or more switches connected to the MST antenna 297-1, and control the switching module to change a direction of a voltage or current supplied to the MST antenna 297-1 according to the received signal. The change in the direction of the voltage or current enables the direction of the magnetic signal (e.g., a magnetic field) transmitted through the MST antenna 297-1 to be changed accordingly. When the magnetic signal in the state in which the direction is changed is detected by the external electronic device 102, the magnetic signal may cause an effect (e.g., waveform) similar to a magnetic field generated while a magnetic card corresponding to the received signal (e.g., card information) is swiped by a card reader of the external electronic device 102. According to an embodiment, authentication-related information and a control signal received in the form of the magnetic signal by the external electronic device 102 may be transmitted to an external server 108 (e.g., authentication server) via, for example, a network 199.

The NFC communication module 230 may include various NFC communication circuitry and acquire a signal including authentication information such as control information or card information from the processor 120 and transmit the acquired signal to the external electronic device 102 through the NFC antenna 297-3. According to an embodiment, the NFC communication module 230 may receive such a signal transmitted from the external electronic device 102 via the NFC antenna 297-3.

The wireless charging module 250 may include various wireless charging circuitry and wirelessly transmit power to the external electronic device 102 (e.g., a mobile phone or a wearable device) via the wireless charging antenna 297-5, or wirelessly receive power from the external electronic device 102 (e.g., a wireless charging device). The wireless charging module 250 may support one or more of various wireless charging schemes, including, for example, a magnetic resonance scheme or a magnetic induction scheme.

According to an embodiment, some of the MST antenna 297-1, the NFC antenna 297-3, or the wireless charging antenna 297-5 may share at least a portion of a radiating element with each other. For example, the radiating element of the MST antenna 297-1 may be used as the radiating element of the NFC antenna 297-3 or the wireless charging antenna 297-5, and vice versa. In this case, the antenna module 297 may include a switching circuit (not illustrated) configured to selectively connect (e.g., close) or disconnect (e.g., open) at least some of the antennas 297-1, 297-3, or 297-3 under the control of the wireless communication module 192 (e.g., the MST communication module 210 or the NFC communication module 230) or the power management module 188 (e.g., the wireless charging module 250). For example, when the electronic device 101 uses a wireless charging function, the NFC communication module 230 or the wireless charging module 250 may control the switching circuit to temporarily disconnect at least a partial area of the radiating element shared by the NFC antenna 297-3 and the wireless charging antenna 297-5 from the NFC antenna 297-3 and connect at least a partial area of the radiating element to the wireless charging antenna 297-5.

According to an embodiment, at least one function of the MST communication module 210, the NFC communication module 230, or the wireless charging module 250 may be controlled by an external processor (e.g., the processor 120). According to an embodiment, specified functions (e.g., the authentication function) of the MST communication module 210 or the NFC communication module 230 may be performed in a trusted execution environment (TEE). The trusted execution environment (TEE) according to various embodiments may form an execution environment in which at least a portion of a specified area of the memory 130 is allocated to perform, for example, a function (e.g., a financial transaction or a personal information-related function) that requires a relatively high level of security. In this case, access to the specified area may be separately and restrictively permitted, for example, depending on a subject accessing the specified area or an application running in the trusted execution environment.

FIG. 2B is a diagram illustrating an example configuration of the electronic device according to various embodiments.

Referring to FIG. 2B, the electronic device 101 may include the wireless communication module 192 (refer to FIG. 1). The electronic device 101 may transmit and/or receive data to and from the external electronic device 102 using the wireless communication module 192.

The electronic device 101 may transmit authentication data via the wireless communication module 192. For example, the authentication data may refer to information stored in a storage module (e.g., memory 130 of FIG. 1) included in the electronic device 101. The storage module may refer to a storage space included in the electronic device 101 or connected to the electronic device 101. For example, a data generation module included in the electronic device 101 may generate the authentication data based on the stored information.

In an embodiment, the authentication data generated by the data generation module may include security data or authentication information. For example, the security data may be obtained by encrypting data stored in the storage module. For example, the authentication information may include, without limitation, a primary account number (PAN), a device account number (DAN), virtual credit card information, a bank information number (BIN), a card security code (CSC), a card verification value (CVV), a cryptogram stored in the storage module, or the like. For example, the wireless communication module 192 may include a data generation module.

In an embodiment, the electronic device 101 may provide a specified authentication process (e.g., password input or fingerprint recognition) during the authentication process. For example, the electronic device 101 may provide authentication information to the external electronic device 102 using a short-range wireless communication scheme such as the NFC communication or the MST communication, and the external electronic device 102 may perform authentication based on the received authentication information.

According to various embodiments, the wireless communication module 192 may include one or more sub-communication modules capable of performing offline authentication. One or more sub-communication modules may include, for example, the MST communication module 210 and/or the NFC communication module 230 (refer to FIG. 2A).

For example, the near field communication (NFC) communication module 230 may support near field communication that enables two-way data communication between devices equipped with an NFC chip at a specified frequency band (e.g., 13.56 MHz). The NFC communication module 230 may operate in a passive communication mode in which the NFC communication module 230 receives power from a magnetic field generated by the external electronic device 102 to form a channel, or in an active communication mode in which the NFC communication module 230 directly generates a magnetic field to form a channel.

The NFC communication module 230 may operate according to a set NFC signal cycle. When the NFC communication module 230 operates in the passive communication mode, the NFC signal cycle may be set to include only a passive communication section. When the NFC communication module 230 operates in an active communication mode, the NFC signal cycle may be set to include the passive communication section and the active communication section.

For example, the MST communication module 210 may be a near field communication module that transmits data using a near field magnetic data stripe transmission scheme. The MST scheme may refer to a scheme of generating a pulse according to transaction data and converting the pulse into a magnetic field signal. In order for the external electronic device 102 to receive data, the sensor (e.g., the MST reader or the header) included in the external electronic device 102 may detect the converted magnetic field signal, and may restore the data by converting the detected magnetic field signal into an electric signal.

The MST communication module 210 may receive the control signal and authentication information from a control circuit inside the electronic device 101. The MST communication module 210 may convert the authentication information into a magnetic signal and transmit the magnetic signal. For example, the MST communication module 210 may generate a magnetic field signal identical to the magnetic field signal generated when swiping a credit card's magnetic stripe (magnetic line) through the external electronic device 102. The authentication information transmitted by the MST communication module 210 may be recognized by the commonly used external electronic device 102. In an embodiment, the MST communication module 210 may provide the authentication information to the external electronic device 102 via one-way communication.

The MST communication module 210 and/or the NFC communication module 230 are only examples of one or more sub-communication modules and are not limited thereto and may further include other short-range wireless communication schemes.

In an embodiment, the electronic device 101 may simultaneously or sequentially transmit the magnetic field signal, for example, the NFC and MST signals, using the wireless communication module 192. For example, the MST communication module 210 and/or the NFC communication module 230 may selectively transmit the authentication information to the external electronic device 102 according to a specified schedule or signal cycle (e.g., 0.2 seconds).

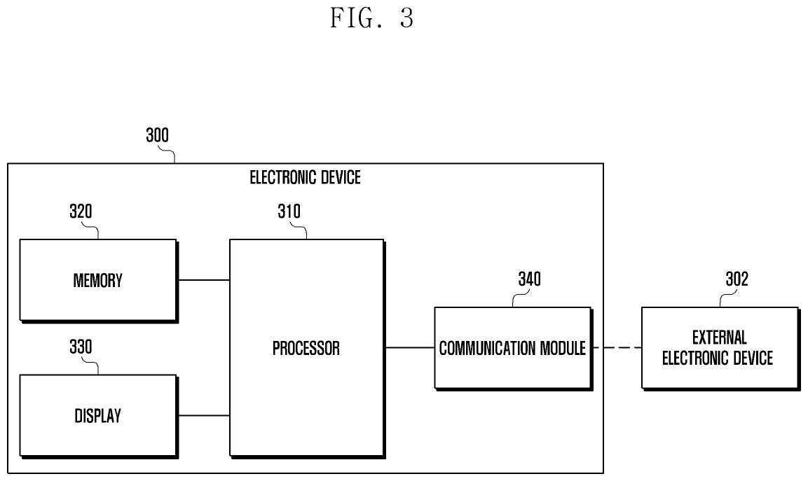

FIG. 3 is a block diagram illustrating an example configuration of the electronic device according to various embodiments.

According to various embodiments, the electronic device 300 may include a processor (e.g., including processing circuitry) 310, a memory 320, a display 330, and a communication module (e.g., including communication circuitry) 340, and some of the illustrated components may be omitted or substituted. The electronic device 300 may further include at least some of the components and/or functions of the electronic device 101 of FIG. 1. At least some of the components of the illustrated (or not illustrated) electronic device 300 may be operatively, functionally, and/or electrically connected to each other.

According to various embodiments, the processor 310 may include various processing circuitry and is capable of performing computational or data processing related to control and/or communication of each component of the electronic device 300, and may include one or more processors. The processor 310 may include at least some of the components and/or functions of the processor 120 of FIG. 1. As set forth above, the processor 120 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

According to various embodiments, there is no limitation to the computational and data processing functions that the processor 310 may implement on the electronic device 300. Hereinafter, however, the features of receiving an application identifier (AID) of the external electronic device and acquiring location information about an antenna to indicate a location at which the electronic device 300 is to be disposed will be described in greater detail. The operations of the processor 310 may be performed by loading instructions stored in the memory 320.

According to various embodiments, the electronic device 300 includes one or more memories 320, and the memory 320 may include a main memory and storage. For example, the main memory 320 may include a volatile memory such as a dynamic random access memory (DRAM), a static RAM (SRAM), or a synchronous dynamic RAM (SDRAM). For example, the memory 320 is the non-volatile memory and may include a large-capacity storage device. For example, the storage may include at least one of one time programmable ROM (OTROM), PROM, EPROM, EEPROM, mask ROM, flash ROM, flash memory, hard drive, or solid state drive (SSD). The memory 320 may store various file data, and the stored file data may be updated according to the operation of the processor 310.

According to various embodiments, the display 330 may display various images under the control of the processor 310. The display 330 may be implemented as, for example, and without limitation, any of a liquid crystal display (LCD), a light-emitting diode (LED) display, an organic light-emitting diode (OLED) display, but is not limited thereto. The display 330 may be formed as a touch screen that detects a touch and/or a proximity touch (or hovering) input using a part of a user's body (e.g., a finger) or an input device (e.g., a stylus pen). The display 330 may include at least some of the components and/or functions of the display module 160 of FIG. 1.

According to various embodiments, the display 330 may be at least partially flexible, and may be implemented as a foldable display or a rollable display.

According to various embodiments, the communication module 340 may include various communication circuitry and communicate with the external electronic device via the wireless network under the control of the processor 310. The communication module 340 may include hardware and software modules for transmitting and receiving data to and from a cellular network (e.g., a long term evolution (LTE) network, a 5G network, a new radio (NR) network) and a short-range network (e.g., Wi-Fi, Bluetooth). The communication module 340 may include at least some of the components and/or functions of the communication module 190 of FIG. 1.

The electronic device 300 may communicate with an external electronic device 302 using the communication module (e.g., the NFC module 127 of FIG. 2) included in the communication module 340. For example, the electronic device 300 may transmit and/or receive the information related to the external electronic device 302 to and from the external electronic device 302 based on the communication.

The external electronic device 302 may communicate with the electronic device 300 based on the communication by driving power. According to various embodiments, the external electronic device 302 may communicate with the electronic device 300 based on the wireless communication module (not illustrated) that does not require power.

According to an embodiment, an applet installed on a security module (not illustrated) may refer, for example, to an applet for performing the authentication of the electronic device 300 in order to use various functions that the external electronic device 302 can provide. For example, the applet may refer, for example, to a key for using the external electronic device 302. For example, when the external electronic device 302 is a vehicle, the applet installed on the security module (not illustrated) may be an applet that manages a key used for authenticating the vehicle. For example, the applet installed on the security module (not illustrated) may be provided by manufacturers of the external electronic device 302.

According to an embodiment, the authentication of the electronic device 300 may refer, for example, to an operation of identifying whether the electronic device 300 has valid authority to perform various functions that the external electronic device 302 can provide. According to an embodiment, the external electronic device 302 may include a vehicle or various electronic devices electrically connected to control the vehicle.

According to an embodiment, in response to receiving a request for access to data on the security module (not illustrated), the processor 310 may perform access authority or integrity verification of a subject (e.g., various applications installed on the memory 130) of a data access request and permit access/editing of data stored on the security module (not illustrated) or transmit the stored data based on the result of the performance.

According to an embodiment, the security module (not illustrated) may include a contactless register service (CRS) that manages the applet used for the external electronic device 302 to perform the authentication. The CRS (not illustrated) may, for example, perform modification, addition, or deletion of data allocated to the applet based on a user's request.

According to an embodiment, the processor 310 may generate an AID list including the application identification (AID) of each of the applets stored on the security module (not illustrated). For example, the processor 310 may transmit the AID list to the external electronic device 302 in response to a request from the external electronic device 302.

According to an embodiment, the external electronic device 302 may select at least one AID to perform the authentication among the AIDs included in the AID list, and transmit a signal, which requests information indicating the selected AID and information related to an applet corresponding to the selected AID, to the electronic device 300.

For example, the information related to the applet may include the information related to the applet corresponding to each of the AIDs when there are multiple AIDs selected by the external electronic device 302. For example, when there are multiple AIDS, the information related to the applet corresponding to each of the AIDs may be transmitted in order of priority. The priority may be set by the user of the electronic device 300, for example. For example, the priority may be changed according to the frequency of use of the external electronic device 302. For example, the higher the frequency of use of the external electronic device 302, the higher the priority may be set.

The electronic device 300 may refer to various electronic devices electrically connected to control the vehicle. Through the authentication of the external electronic device 302, the electronic device 300 may perform at least some (for example, a function of unlocking a door of the electronic device 300 or start an engine of the electronic device 300) of various functions that the electronic device 300 can perform.

The processor 310 may start the authentication with the external electronic device 302 in response to receiving a signal requesting that the electronic device 300 perform some of the functions. According to an embodiment, the processor 310 may receive the information related to the applet from the external electronic device 302. The processor 310 may perform the authentication with the external electronic device 302 using the information related to the applet.

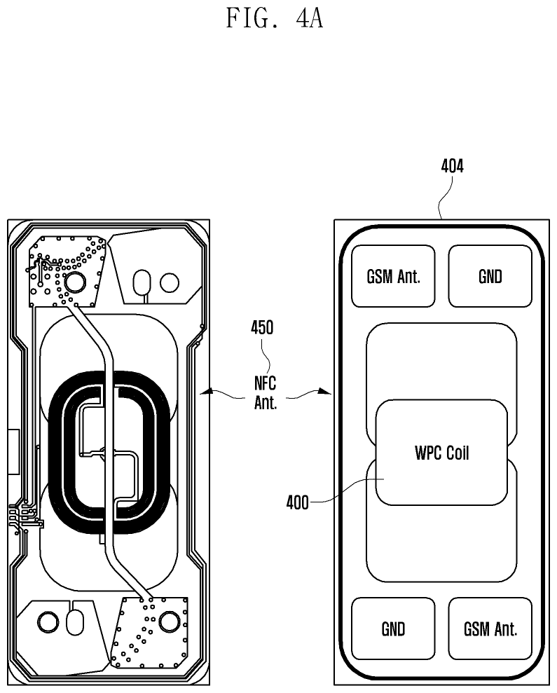

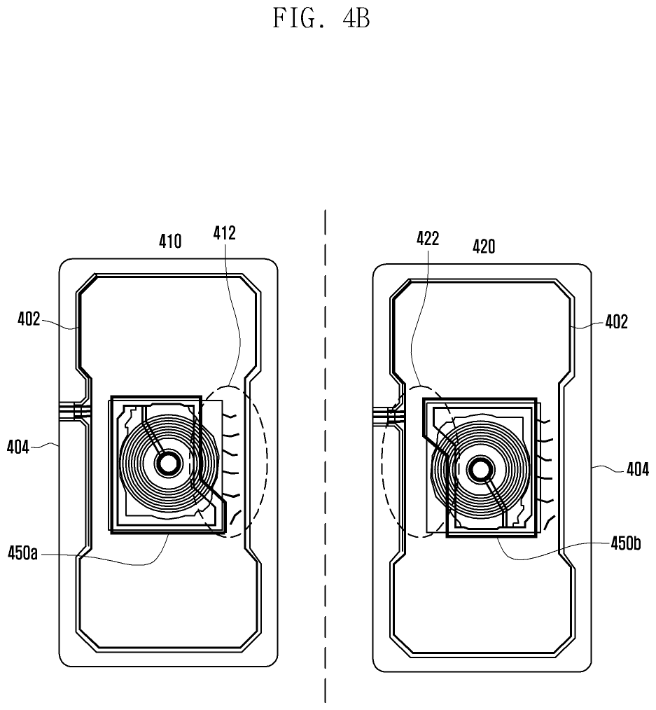

FIG. 4A is a diagram illustrating an example antenna structure of the reader of the external electronic device according to various embodiments.

Referring to FIG. 4A, an NFC reader 404 of the external electronic device (e.g., a car) may include an NFC antenna 450, a wireless power consortim (WPC) coil 400, or at least one GSM antenna. The following description assumes that the external electronic device is a car, but the type of the external electronic device is not limited thereto.

In an embodiment, the NFC reader 404 of the external electronic device (e.g., a car) may perform wireless charging using a wireless power consortium (WPC) coil (or wireless charging coil) 400. The NFC reader 404 of the external electronic device (e.g., a car) may have limitations in reducing the size of the NFC antenna 450 due to the size of the WPC coil 400.

In an embodiment, the NFC antenna 450 is positioned to surround the WPC coil 400, and since the size of the NFC antenna 450 is relatively different in width and height compared to the NFC antenna of the electronic device 300 (e.g., the NFC antenna 297-3 of FIG. 2A), the coupling between the antennas may be difficult. A situation where the coupling between the antennas is difficult will be described in FIG. 4B.

FIG. 4B is a diagram illustrating a situation where the electronic device (e.g., a terminal) is disposed on the NFC reader 404 of the external electronic device according to various embodiments.

Referring to FIG. 4B, in reference numeral 410, a terminal 402 may be disposed on the NFC reader 404 of the external electronic device (e.g., a car) in a first direction.

In this case, since the size of the antenna 450a in the NFC reader 404 of the car is relatively large compared to the size of the antenna of the terminal 402, a space 412 in which there is no matching between the antennas may occur. The terminal 402 may have limitations in increasing the size of the housing of the terminal 402. Accordingly, there is a limitation in the mounting space in which various components included in the terminal 402 are to be disposed, and there may be limitations in expanding the size of the antenna within the terminal 402 due to the limitation in the mounting space.

In this situation, the user may attempt to smooth the communication between the antennas by disposing the terminal 402 mounted on the NFC reader 404 of the car in a different manner. In reference numeral 420, the terminal 402 may be mounted on the NFC reader 404 of the car in a second direction opposite to the first direction. In this case, since the size of the antenna 450b in the NFC reader 404 of the car is relatively large compared to the size of the antenna of the terminal 402, a space 422 in which there is no matching between the antennas may occur.

As the space 422 where there is no matching between the antennas becomes larger, the coupling between the antennas between the terminal 402 and the NFC reader 404 of the car may become relatively weaker. When the coupling between the antennas between the terminal 402 and the NFC reader 404 of the car becomes weaker, the NFC reader 404 of the car may have difficulty receiving an NFC response signal of the terminal 402.

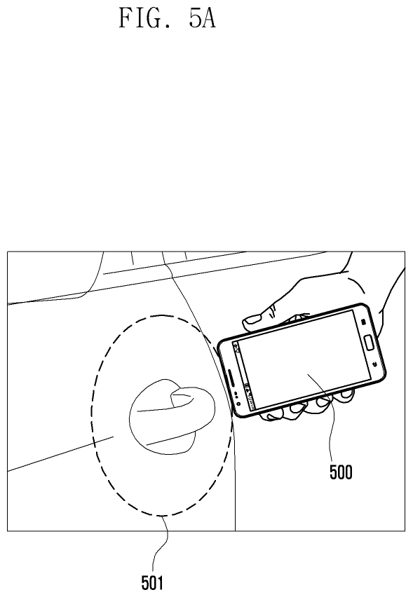

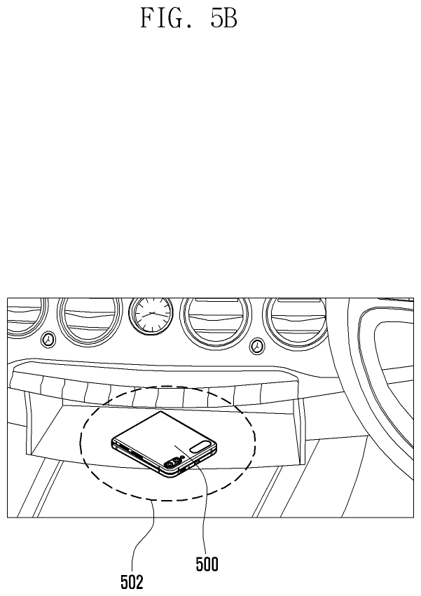

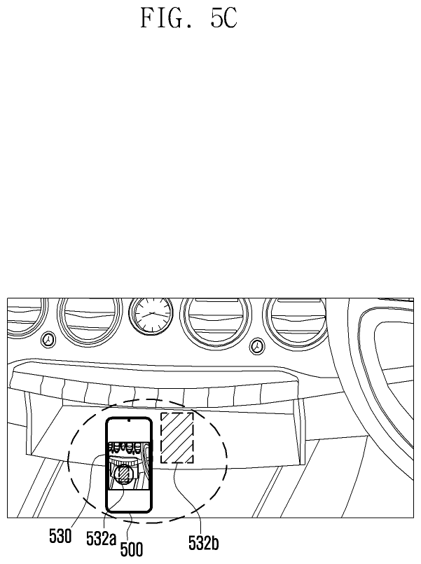

FIG. 5A is a diagram illustrating an example situation where the electronic device is recognized on a first NFC antenna according to various embodiments.

In FIG. 5A, a first NFC antenna 501 of the external electronic device (e.g., a car) may be included on an NFC pad within a door handle of the external electronic device. When an electronic device 500 (e.g., an electronic device 300 of FIG. 3) approaches within a specified distance from the first NFC antenna 501, the electronic device 500 may perform the communication connection using the communication module (e.g., a communication module 190 of FIG. 1). The electronic device 500 may perform the authentication using the communication connection with the first NFC antenna 501 and open or lock the door of the external electronic device (e.g., a car, a vehicle). The electronic device 500 may perform various functions through the communication connection with the first NFC antenna 501, which will be described in FIG. 5B.

FIG. 5B is a diagram illustrating an example situation where the electronic device is recognized on a second NFC antenna according to various embodiments.

In FIG. 5B, a second NFC antenna 502 may be included in the NFC reader within the external electronic device (e.g., a car). When the electronic device 500 approaches within the specified distance from the second NFC antenna 502, the electronic device 500 may perform the communication connection using the communication module (e.g., the communication module 190 of FIG. 1). For example, the electronic device 500 may start (on) the car using the communication connection with the second NFC antenna 502.

As described in FIG. 4B above, the antenna size of the electronic device 500 is relatively small, and the size of the second NFC antenna 502 is relatively large, which may make recognition difficult. The electronic device 500 may have difficulty performing smooth communication with the second NFC antenna 502 due to the difference in the antenna sizes. When the communication connection between the electronic device 500 and the second NFC antenna 502 is not performed well, a user may have to change the location on the electronic device 500 to start a car or try to start a car several times, which may reduce usability. In addition, if the communication connection between the electronic device 500 and the second NFC antenna 502 is not performed well in an emergency situation where a car start is suddenly turned off on a road, the electronic device 500 may have difficulty performing a user request to start a car. For this reason, when the communication connection is not performed well, the electronic device 500 may pose a great danger to other cars or users on a road.

The electronic device 500 supporting the NFC operation mode according to an embodiment of the present disclosure may receive the information about the second NFC antenna 502 based on the authentication with the first NFC antenna 501 and display an image of a location suitable for NFC communication connection on the second NFC antenna 502. The electronic device 500 may display an image of a location suitable for the NFC communication connection on the second NFC antenna 502 to guide the user to mount the electronic device 500 at a location at which the NFC communication with the second NFC antenna 502 is smoothed. The electronic device 500 may smoothly control the NFC communication connection to enable the car to start at once, thereby increasing the user experience. For example, the electronic device 500 may smoothly control the NFC communication connection to enable a cart to start quickly in an emergency situation where the car start is turned off on a road, thereby reducing the user's danger.

FIG. 5C is a diagram illustrating an example situation where the electronic device is recognized on the second NFC antenna according to various embodiments.

The electronic device 500 may display the external electronic device including the second NFC antenna 502 on a display 530. The electronic device 500 may display, on the display 530, a location 532a within the external electronic device at which the communication connection with the second NFC antenna 502 can be established. The electronic device 500 may display, on the display 530, the location 532a at which the communication connection with the second NFC antenna 502 can be established, thereby guiding the user to position the electronic device 500 at a location 532b on the external electronic device at which the communication connection can be established.

According to an embodiment, the electronic device 500 may display, on the display 530, the location 532a at which the communication connection with the second NFC antenna 502 can be established, and may display the location 532a at which the communication connection can be established in a different color or may highlight the location 532a. The electronic device 500 may establish the communication connection based on that the electronic device 500 is positioned at the location 532b on the external electronic device at which the communication connection can be established, and may guide the user that the communication connection has been established using voice or the display 530. The electronic device 500 may guide the user through voice or the display 530 that the communication connection has not yet been established and that location adjustment is necessary based on that the electronic device 500 is not positioned at the location 532b on the external electronic device at which the communication connection can be established. The electronic device 500 may provide the user with a guide for changing the location of the electronic device 500 through the display 530 based on that the electronic device 500 is not positioned at the location 532b on the external electronic device at which the communication connection can be established.

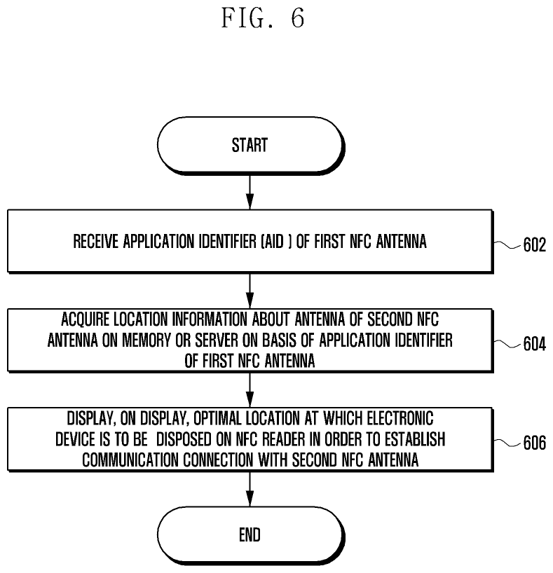

FIG. 6 is a flowchart illustrating an example method of operating an electronic device supporting an NFC operation mode according to various embodiments.

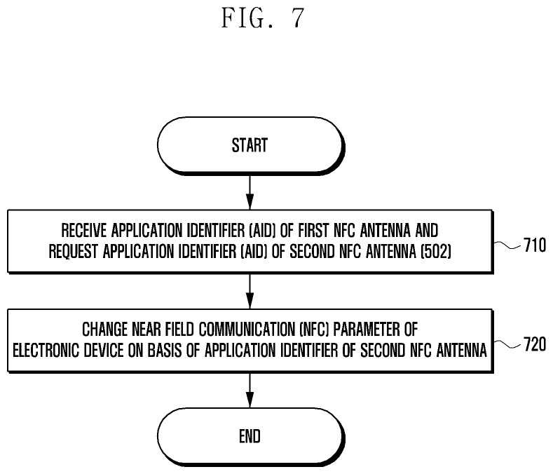

The operations described with reference to FIG. 6 may be implemented based on instructions that may be stored in the computer recording medium or the memory (e.g., the memory 130 of FIG. 1). An illustrated method may be executed by the electronic device (e.g., the electronic device 300 of FIG. 3) described with reference to FIGS. 1 to 5B above, and therefore, the technical features described above may not be repeated here. The order of each operation of FIG. 6 may be changed, some operations may be omitted, and some operations may be performed simultaneously. The operations of FIG. 6 may be performed in combination with the operations of FIG. 7.

In operation 602, the processor (e.g., processor 310 of FIG. 3) may receive an application identifier (AID) of the first NFC antenna (e.g., the first NFC antenna 501 of FIG. 5A) within a handle of the external electronic device (e.g., the external electronic device 302 of FIG. 3). The processor 310 may detect that the first NFC antenna 501 is positioned within a specified distance from the electronic device 300, request the authentication for the communication connection, and request the application identifier (AID) of the first NFC antenna 501 based on that the communication connection is established. The processor 310 may determine the second NFC antenna 502 related to the external electronic device (e.g., car) based on that the application identifier (AID) of the first NFC antenna 501 is received, and request an application identifier (AID) of the second NFC antenna 502 (e.g., the second NFC antenna 502 of FIG. 5B).

According to an embodiment, the authentication of the electronic device 300 may refer, for example, to a procedure of identifying whether the electronic device 300 has valid authority to perform various functions that the external electronic device (e.g., the external electronic device 302 of FIG. 3) can provide. According to an embodiment, the external electronic device 302 may refer, for example, to a vehicle (e.g., a car).

The electronic device 300 may refer to various electronic devices electrically connected to control the external electronic device 302 (e.g., vehicle). Through the authentication of the external electronic device 302, the electronic device 300 may perform at least some (for example, a function of unlocking a door of the electronic device 300 or start the engine of the electronic device 300) of various functions that the electronic device 300 can perform.

In an embodiment, the processor 310 may start the authentication with the external electronic device 302 in response to receiving a signal requesting that the electronic device 300 perform some of the functions. According to an embodiment, the processor 310 may receive the information related to the applet from the external electronic device 302. The processor 310 may perform the authentication with the external electronic device 302 using the information related to the applet.

According to an embodiment, an applet installed on a security module (not illustrated) may refer, for example, to an applet for performing the authentication of the electronic device 300 in order to use various functions that the external electronic device 302 can provide. For example, the applet may refer, for example, to a key for using the external electronic device 302. When the external electronic device 302 is a vehicle, the applet installed on the security module (not illustrated) may be an applet that manages a key used for authenticating the vehicle. The applet installed on the security module (not illustrated) may be provided by manufacturers of the external electronic device 302.

According to an embodiment, the first NFC antenna 501 may include an NFC antenna of a car door, and the second NFC antenna 502 may include an NFC antenna inside the car. The processor 310 may control to open the door of the car linked to the first NFC antenna 501 based on that the communication connection with the first NFC antenna 501 is established. According to an embodiment, the processor 310 may change near field communication (NFC) parameters of the electronic device 300 to smooth NFC communication performance with the second NFC antenna 502 based on that the application identifier (AID) of the second NFC antenna 502 is received. The near field communication parameters of the electronic device 300 will be described in greater detail below with reference to FIG. 7.

In operation 604, the processor 310 may acquire location information about the second NFC antenna 502 on the memory 130 or the server based on the application identifier of the second NFC antenna 502.

According to an embodiment, the processor 310 may search for, on the memory 130, the location information about the second NFC antenna 502 related to the internal NFC reader of the external electronic device 302 based on that the communication connection with the first NFC antenna 501 is established or the application capable of driving the external electronic device 302 is running. The processor 310 may request the location information about the second NFC antenna 502 from the server of the application capable of driving the external electronic device 302.

In operation 606, the processor 310 may display, on the display, an optimal location at which the electronic device 300 is to be disposed on the NFC reader in order to establish the communication connection with the second NFC antenna 502. For example, the optimal location may refer, for example, to a location at which the smooth communication is possible between the electronic device 300 and the second NFC antenna 502.

According to an embodiment, the processor 310 may display, on the display, a location at which the communication between the antenna of the electronic device 300 and the second NFC antenna 502 is possible. For example, the location at which the communication between the antenna of the electronic device 300 and the second NFC antenna 502 is possible may refer, for example, to the location at which the coupling may occur because an overlapping area between the antennas exceeds a specified level. For example, the processor 310 may delete information indicating the location of the electronic device 300 displayed on the display based on that the communication connection with the second NFC antenna 502 is established, and display an interface related to the car start linked to the external electronic device 302. For example, the information indicating the location of the electronic device 300 or the interface related to the car start linked to the external electronic device 302 may be displayed on the display in the form of a pop-up.

FIG. 7 is a flowchart illustrating an example method of operating an electronic device supporting an NFC operation mode according to various.

The operations described with reference to FIG. 7 may be implemented based on instructions that may be stored in the computer recording medium or the memory (e.g., the memory 130 of FIG. 1). An illustrated method may be executed by the electronic device (e.g., the electronic device 300 of FIG. 3) described with reference to FIGS. 1 to 5B above, and therefore, the technical features described above may not be repeated here. The order of each operation of FIG. 7 may be changed, some operations may be omitted, and some operations may be performed simultaneously.

In operation 710, the processor (e.g., processor 310 of FIG. 3) may receive the application identifier (AID) of the first NFC antenna (e.g., the first NFC antenna 501 of FIG. 5A). The processor 310 may detect that the first NFC antenna 501 is positioned within a specified distance from the electronic device 300, request the authentication for the communication connection, and request the application identifier (AID) of the first NFC antenna 501 based on that the communication connection is established. The processor 310 may determine the second NFC antenna (e.g., the second NFC antenna 502 of FIG. 5B) related to the external electronic device (e.g., a car) (e.g., the external electronic device 302 of FIG. 3) based on that the application identifier (AID) of the first NFC antenna 501 is received, and request the application identifier (AID) of the second NFC antenna 502.

According to an embodiment, the first NFC antenna 501 may include the NFC antenna of the car door, and the second NFC antenna 502 may include the NFC antenna inside the car. The processor 310 may control to open the door of the car linked to the external electronic device 302 based on that the communication connection with the first NFC antenna 501 is established.

In operation 720, the processor 310 may change the near field communication (NFC) parameters of the electronic device 300 to smooth the NFC communication performance with the second NFC antenna 502 based on that the application identifier (AID) of the second NFC antenna 502 is received.

According to an embodiment, the processor 310 may update the near field communication (NFC) parameters of the electronic device 300 to match the second NFC antenna 502. The processor 310 may update the near field communication (NFC) parameters so that the strength of the NFC communication sensitivity between the electronic device 300 and the second NFC antenna 502 may exceed the specified level or the strength of the radio frequency (RF) may exceed the specified level. For example, the processor 310 may add an option (e.g., 0x00 to 0x03) to maximize or optimize a value of TX amp depending on a protocol type (e.g., types A, B, and F) of the second NFC antenna 502 and adjust a field section in which a power supply bypasses.

According to an embodiment, the near field communication parameters of the electronic device 300 may include a gain and/or sensitivity for the field strength. The near field communication parameters of the electronic device 300 may be changed based on the protocol type of the second NFC antenna 502. The processor 310 may change the near field communication (NFC) parameters of the electronic device 300 based on the application identifier of the second NFC antenna 502 and store the existing parameter in the memory 130. The processor 310 may return the near field communication parameters of the electronic device 300 to the existing parameters stored in the memory 130 based on that the car start linked to the second NFC antenna 502 is turned off and the communication connection with the first NFC antenna 501 is interrupted.

The electronic device may include the communication circuit for establishing the NFC communication connection with the external electronic device, the memory, and the processor. The processor may receive the application identifier (AID) of the first device based on that the communication connection with the first device is established or the application capable of driving the first device is running, acquire the location information about the antenna of the second device related to the first device on the memory or the server based on the application identifier of the first device, and display, on the display, the location at which the electronic device is to be disposed on the second device in order to establish the communication connection with the second device based on the location of the antenna of the second device and the location of the antenna of the electronic device.

According to an embodiment, the first device may include the NFC antenna of the car door, and the second device may include the NFC antenna inside the car. The processor may receive the application identifier (AID) of the second device related to the first device based on that the communication connection with the first device is established or the application capable of driving the first device is running, and search for, on the memory, the location information about the NFC antenna of the second device related to the first device or request the server of the application capable of driving the first device.

According to an embodiment, the processor may detect that the first device is positioned within the specified distance from the electronic device, request the authentication for the communication connection, and request the application identifier (AID) of the first device based on that the communication connection is established.

According to an embodiment, the processor may determine the second device related to the first device based on that the application identifier (AID) of the first device is received, and request the application identifier (AID) of the second device.

According to an embodiment, the processor may determine the internal structure and the location of the antenna of the second device based on that the application identifier (AID) of the second device is received, and determine the location at which the antenna of the electronic device and the antenna of the second device may be matched.

According to an embodiment, the location at which the antenna of the electronic device and the antenna of the second device may be matched may refer, for example, to the location at which the overlapping area between the antennas exceeds the specified level and the coupling may occur, and the processor may display, on the display, the location at which the antenna of the electronic device and the antenna of the second device may be matched.

According to an embodiment, the processor may delete the information indicating the location of the electronic device displayed on the display based on that the communication connection with the second device is established, and display the interface related to the car start linked to the second device.

According to an embodiment, the information indicating the location of the electronic device or the interface related to the car start linked to the second device may be displayed on the display in the form of the pop-up.

According to an embodiment, the processor may receive the application identifier (AID) of the first device and the application identifier (AID) of the second device related to the first device based on that the communication connection with the first device is established or the application capable of driving the first device is running, and may change the parameters related to the near field communication (NFC) of the electronic device based on the application identifier of the second device.

According to an embodiment, the near field communication parameters of the electronic device may include the gain and sensitivity for the field strength and may be changed based on the protocol type of the second device.

According to an embodiment, the processor may change the near field communication (NFC) parameters of the electronic device based on the application identifier of the second device, and store the existing parameters in the memory.

According to an embodiment, the processor may return the near field communication parameters of the electronic device to the existing parameters stored in the memory based on that the car start linked to the second device is turned off and the communication connection with the first device is interrupted.

The operation method for an electronic device including an NFC antenna may include receiving the application identifier (AID) of the first device based on that the communication connection with the first device is established or the application capable of driving the first device is running, acquiring the location information about the antenna of the second device related to the first device on the memory or the server based on the application identifier of the first device, determining the location of the electronic device for establishing the communication connection with the second device based on the location of the antenna of the second device and the location of the antenna of the electronic device, and displaying, on the display, the information indicating the determined location of the electronic device.

While the disclosure has been illustrated and described with reference to various example embodiments, it will be understood that the various example embodiments are illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. An electronic device, comprising:
a communication circuitry configured to establish an NFC communication connection with an external electronic device;
memory; and
at least one processor, comprising processing circuitry;
wherein at least one processor, individually and/or collectively, is configured to cause the electronic device to:
receive an application identifier (AID) of a first device based on a communication connection with the first device being established or an application driving the first device running;
acquire information on an antenna of a second device related to the first device from the memory or a server based on the application identifier of the first device; and
display, on a display, a guide indicating a location at which the electronic device is to be disposed in order to establish communication connection with the second device based on a location of the antenna of the second device and a location of an antenna of the electronic device.

2. The electronic device of claim 1, wherein the first device includes an NFC antenna on a car door, and
the second device includes an NFC antenna inside the car,
at least one processor, individually and/or collectively, is configured to cause the electronic device to:
receive an application identifier (AID) of the second device related to the first device based on the communication connection with the first device being established or the application driving the first device running, and
searche for, on the memory, location information about an NFC antenna of the second device related to the first device or request a server of the application driving the first device.

3. The electronic device of claim 1, wherein at least one processor, individually and/or collectively, is configured to cause the electronic device to:
detect that the first device is positioned within a specified distance from the electronic device and request authentication for the communication connection, and
request the application identifier (AID) of the first device based on the communication connection being established.

4. The electronic device of claim 3, wherein at least one processor, individually and/or collectively, is configured to cause the electronic device to:
determine the second device related to the first device based on the application identifier (AID) of the first device being received, and
request an application identifier (AID) of the second device.

5. The electronic device of claim 4, wherein at least one processor, individually and/or collectively, is configured to:
determine an internal structure and the location of the antenna of the second device based on the application identifier (AID) of the second device being received, and
determine a location at which the antenna of the electronic device and the antenna of the second device are matched.

6. The electronic device of claim 5, wherein the location at which the antenna of the electronic device and the antenna of the second device are matched includes a location at which an overlapping area between the antennas exceeds a specified level and coupling occurs, and
at least one processor, individually and/or collectively, is configured to cause the electronic device to display on the display, the location at which the antenna of the electronic device and the antenna of the second device are matched.

7. The electronic device of claim 1, wherein at least one processor, individually and/or collectively, is configured to cause the electronic device to: delete information indicating the location of the electronic device displayed on the display based on the communication connection with the second device being established, and display an interface related to a car start linked to the second device.

8. The electronic device of claim 7, wherein information indicating the location of the electronic device or the interface related to the car start linked to the second device is displayed on the display in a form of a pop-up.

9. An electronic device, comprising:
a communication circuitry configured to establish an NFC communication connection with an external electronic device;
memory; and
at least one processor, comprising processing circuitry:
wherein at least one processor, individually and/or collectively, is configured to cause the electronic device to:
receive an application identifier (AID) of a first device and an application identifier (AID) of a second device related to the first device based on a communication connection with the first device being established or an application driving the first device running, and
change a near field communication (NFC) parameter of the electronic device based on the application identifier of the second device.

10. The electronic device of claim 9, wherein the near field communication parameter of the electronic device includes a gain and sensitivity for field strength, and
the near field communication parameter is changed based on a protocol type of the second device.

11. The electronic device of claim 9, wherein at least one processor, individually and/or collectively, is configured to cause the electronic device to:
change the near field communication (NFC) parameter of the electronic device based on the application identifier of the second device, and
store an existing parameter in the memory.

12. The electronic device of claim 11, wherein at least one processor, individually and/or collectively, is configured to cause the electronic device to: return the near field communication parameter of the electronic device to the existing parameter stored in the memory based on a car start linked to the second device being turned off and the communication connection with the first device being interrupted.

13. A method of operating an electronic device including an NFC antenna, comprising:
receiving an application identifier (AID) of a first device based on a communication connection with the first device being established or an application driving the first device running;
acquiring information on an antenna of a second device related to the first device from a memory or a server based on the application identifier of the first device;
determining a guide indicating a location of the electronic device for establishing communication connection with the second device based on a location of the antenna of the second device and a location of an antenna of the electronic device; and
displaying information indicating the determined location of the electronic device on a display.

14. The method of claim 13, wherein the first device includes an NFC antenna on a car door, and
the second device includes an NFC antenna inside a car,
the receiving of an application identifier of the second device related to the first device further comprising:
based on the communication connection with the first device being established or the application driving the first device running,
receiving the application identifier (AID) of the second device related to the first device; and
searching for, on the memory, location information about the NFC antenna of the second device related to the first device or requesting the server of the application driving the first device.

15. The method of claim 13, wherein the receiving of the application identifier of the first device further comprising:
detecting that the first device is positioned within a specified distance from the electronic device and requesting authentication for the communication connection; and
requesting the application identifier (AID) of the first device based on the communication connection being established.

16. The method of claim 15, further comprising:
determining the second device related to the first device based on the application identifier (AID) of the first device being received; and
requesting an application identifier (AID) of the second device.

17. The method of claim 16, wherein the determining of the location of the electronic device for establishing the communication connection with the second device further comprising:
determining an internal structure and the location of the antenna of the second device based on the application identifier (AID) of the second device being received; and
determining a location at which the antenna of the electronic device and the antenna of the second device are matched.

18. The method of claim 17, wherein the location at which the antenna of the electronic device and the antenna of the second device are matched includes a location at which an overlapping area between the antennas exceeds a specified level and coupling occurs, and
the displaying of the information indicating the determined location of the electronic device on the display further comprising:
displaying, on the display, the location at which the antenna of the electronic device and the antenna of the second device are matched.

19. The method of claim 18, further comprising:
deleting information indicating the location of the electronic device displayed on the display based on the communication connection with the second device being established, and displaying an interface for asking whether to start a car linked to the second device.

20. The method of claim 19, wherein the information indicating the location of the electronic device or the interface for asking whether to start the car linked to the second device is displayed on the display in a form of a pop-up.
